(19) United States
(12) Patent Application Publication
(10) Pub. No.: US 2009/0160177 A1
(43) Pub. Date: Jun. 25, 2009

(54) METHOD OF INDIVIDUALIZING LABELS

(75) Inventors: Christoph Dietrich, Heidelberg (DE); Steffen Noehte, Weinheim (DE)

Correspondence Address: NORRIS, MCLAUGHLIN & MARCUS, 875 THIRD AVE, 18TH FLOOR, NEW YORK, NY, 10022, US

(73) Assignee: TESA SCRIBOS GMBH, Heidelberg (DE)

(21) Appl. No.: 12/180,263

(22) Filed: Jul. 25, 2008

(30) Foreign Application Priority Data
Dec. 20, 2007 (DE) 10 2007 062 426.5

(51) Int. Cl. B31D 1/02

(52) U.S. Cl. 283/70; 283/81

(57) ABSTRACT

Method of individualizing labels, in which a plurality of labels is formed from a label tape, characterized in that the shape of each label is formed individually.

The present invention relates to a method of individualizing labels in accordance with the preamble of claim 1, and also to a label in accordance with the preamble of claim 12.

A label is typically a layer arrangement of limited extent which is used for purposes of identification. In the case of a label, more particularly, length and width are greater than the thickness of the layer arrangement. A label advantageously, though not necessarily, has a layer of adhesive for application to an article that is to be identified, and where appropriate has a liner for the protection of the adhesive layer. A sheet or a strip of the label material is referred to presently as label tape. The label tape, where appropriate, further comprises a backing. From a label tape it is possible for two or more labels to be obtained by cutting or punching of the label tape.

From the prior art it is known to offer plate sets, in the form of label sets, in which the individual labels belonging to the set on the one hand carry arbitrary information printed on an information layer arrangement and on the other hand are differently shaped, i.e. have a different outer shape (WO 2006/108269 A1). The shaping is governed by the site intended for application of the particularly label and is intended to reduce the risk of mistakes at the stage of the positioning of the individual label. The plate sets themselves, however, are of identical design and differ from the other plate sets only in the different information they carry.

With respect to safety identifications of any kind that are employed in order to secure products or packaging, for example, against counterfeiting, there is a desire to perform simple verification of the authenticity of the security identification even without auxiliary means, even where appropriate by the end customer. Features which permit this are also referred to as level 1 security features.

A level 1 security feature is a feature which is visible to the naked eye and can be verified without further auxiliary means, examples being codes such as logos or serial numbers which can be read in daylight. A level 2 security feature is a feature which can be verified with simple or standard auxiliary means (e.g. a magnifying glass, UV lamp or barcode reader). A level 3 security feature is a feature which can be verified only with specialist equipment. More particularly, individualized holographic data can be stored as a level 3 security feature or even, in the case of digital holographic data, as a level 4 security feature. The verification of a level 4 security feature requires additional knowledge concerning the security feature, such as a digital code, for example.

Particularly in the case of the level 1 security features there is a problem in that the test for authenticity is carried out mostly by individuals who have not been initiated into the technical details of the feature. For this reason it is advantageous to find features which, on the one hand, are technically challenging and hence difficult to counterfeit, but on the other hand are so easy to communicate that they are easily remembered or, ideally, are in fact intuitively self-explanatory.

In the art, one such feature is known under the Holospot® name in the form of specially designed labels. The Holospot® has a feature of security level 1 which can be read even without auxiliary means. With a very high resolution, a diffractively shimmering serial number is written onto a label in such a way that it can be seen by the naked eye and any user is able to examine, without auxiliary means, whether the shimmering and the differentiated adhesiveness of the serial numbers exist from one product to another.

Furthermore, it is known from the prior art that information is often introduced in coded form, as for example in the form of a computer-generated hologram, into a storage layer arrangement of a label (DE 10039370 A1; DE 101 28902 A1). Computer-generated holograms of this kind are composed of one or more layers of dot matrices or dot distributions which, when exposed to a preferably coherent beam of light, lead to reconstruction of the information coded in the hologram. The dot distribution may be designed as an amplitude hologram or phase hologram and may be calculated, for example, as a kinoform, Fourier or Fresnel hologram or in any desired other coding structure. For the production of computer-generated holograms, these are first calculated and then written into the data medium using a suitable writing device, generally a laser lithograph, by dot wise introduction of energy or by areal exposure to light. In principle, therefore, there are two different methods of storing computer-generated holograms (CGH):
1. A CGH can be stored by the alteration of the local properties of a polymer support, for example, in the form of a phase hologram.
2. A CGH can be stored in an aluminium layer, for example, by the structuring of that layer. Storage may take place in the form of an amplitude hologram (holes in the aluminium layer) or in the form of a phase hologram, by deformation of the aluminium layer (relief holograms). This structuring is accompanied, where appropriate, by a deformation of adjacent materials, such as polymer supports, adhesives or the like.

The calculation of the computer-generated holograms may take place individually, in other words uniquely for each object to be identified. The resolution of the dot matrix of the computer-generated hologram may be situated in the range down to below 0.1 μm. Accordingly it is possible in narrow confinements to write holograms with a high resolution, whose information can be read by illumination with a light beam and reconstruction of the diffraction pattern. The size of the holograms in this case can be between less than 1 mm² and several cm².

In the case of the known labels, the individualization of the individual labels plays a very important part, since it is always associated, irrespective of the particular production technique of the label, with a higher level of complexity than when labels are identical. Furthermore, the individualization, more particularly in the form of a serial number, is easy to communicate as a distinguishing feature and can therefore be examined in broad application. Since, however, it continues to be a feature which is read by untrained individuals, there is still a desire, while retaining clear and simple communication and verification, to make this plane more complex and more demanding, in order to make copying more difficult.

The problem on which the present invention is based is that of specifying labels with easily recognizable security features, and also methods of producing such labels.

The present problem is solved in the case of a method of individualizing labels that has the features of the preamble of claim 1, by virtue of the features of the characterizing clause of claim 1. A co-independent solution is described by a label according to claim 12. Advantageous embodiments and developments are subject matter of the respective dependent claims.

Critical to easy verification of a security feature, by users for example, is a very simple perception of the security feature. In the present case this is achieved by each label produced from a label tape acquiring an individual shape, in other words an individual external design. The individual alteration of the external design is on the one hand perceived quickly and, furthermore, is also easy to communicate. Complex and laborious training schemes and information campaigns for the communication of a security feature of this kind are not absolutely necessary.

The forming of the individual shape of each label is accomplished preferably by conventional techniques such as individual cutting or punching of the label web. Examples of such are punching techniques, with changing punching shapes, or else blade cuts, of the kind employed in cutting plotters, or alternatively IR cutting or water-jet cutting. In a very preferred embodiment the forming of the individual shape is accomplished by laser lithography, in other words by means of a laser whose jet scans over the label web and cuts the desired shape at the same time. Suitable for the realization of this are, for example, laser systems in accordance with EP 1 837 171 A1 and U.S. Pat. No. 6,860,050 B2 in combination with suitable optical scanning units. More particularly it is also possible to cut a label web in such a way that the label-forming material itself and also any adhesive layer provided is cut in the desired way, but that an underlying backing layer remains substantially intact. This embodiment allows the labels to be matrix-stripped and/or dispensed in a particularly simple way.

Also particularly advantageous in this case is an embodiment in which the shape of the label becomes a carrier of further information. Additional information in this sense is information which is dictated by the shape of the label and which, depending on embodiment, can be read with more or less involved techniques. Such additional information may be, for example, an embodiment of the label in alphanumeric form, in other words such that the label reproduces alphanumeric characters in its shape. An embodiment of this kind is immediately recognizable by anyone. Where, furthermore, the information is coupled with other information provided on the label, such as with an imprint, for example, immediate inspection is possible, furthermore. The additional information may, or may additionally, be provided in such a way that it can be read only with special devices. In this case, for example, a design of the label similar to a barcode is suitable. The label may, at its margin or else in the interior, have one or more cutouts which represent encoded additional information on the principle of a barcode. In this case, special knowledge and readers are necessary in order to evaluate the additional information. Provision may also be made for the additional information to be hidden. This is the case, for example, when information is encoded by the area of the label. As a result of the individual shaping of the label, the area is freely adjustable and can therefore be used to reproduce information, without this being apparent to third parties. In this case as well, special devices are then needed in order to decode the information, in other words to evaluate the area, and also to carry out coding.

In a particularly preferred embodiment of the method, the shape of the label and also the additional information provided where appropriate are dictated by a computer-controlled system and stored in a database in respect of each individual label. This creates a possibility of examining, even at a later point in time, the extent to which a specific label was ever produced and whether, accordingly, it may be an original. With particular preference the shape of the label is stored together with further information relating to the label, more particularly with primary information introduced on the label. Primary information is that information which is disposed on the label itself, in the form for example of an imprint, a laser inscription, a computer-generated hologram or the like. The primary information may comprise, more particularly, data such as serial numbers, information on production and sales routes, product series, etc.

In a particularly preferred embodiment, the individual form of each label will be correlated with further individual features of a label. These further features may be diverse, but with particular preference correlation is carried out with primary information which may be present, for example, as an imprint, hologram, embossing, laser marking and, more particularly, a computer-generated hologram. The additional information formed by the shape may reproduce the primary information, for example, partially or else completely, in unencoded or encoded form. By means of such redundancy it is possible, more particularly when the primary information is also technically complex, such as a computer-generated hologram, for example, to achieve a significant increase in the anti-counterfeiting quality of each label. As a result of the correlation with a typical security feature, in this case preferably with the security features of an individual computer-generated hologram (open diffractive number—level 1 security feature, diffractive microscript—level 2 security feature, projection hologram with analogous content—level 3 security feature, and projection hologram with digital content—level 4 security feature), the individually formed shape of the label is additionally secured and hence may likewise be termed a security feature.

In the case of an embodiment of the primary information as a computer-generated hologram, the forming of the individual shape of the label by laser lithography is particularly advantageous. In this case it is possible for the same laser lithograph both to introduce the primary information into the label tape and to carry out individual forming of the respective label in the label tape. Additional cutting devices, therefore, are unnecessary.

In a further-preferred embodiment of the process, the primary information located in the label tape is formed machine-readably. In that case, for the individualization of the individual labels, preferably, first this primary information is read and, as a function of the primary information, individual shaping takes place for each individual label. More particularly, it is also possible in this way to remove unreadable primary information directly, by virtue of the fact that no label is formed at this point. Instead, the label tape remains intact in this region. When the labels are matrix-stripped, this region is then removed together with the usual trimmings, but an illegible label is avoided. Determining the respective label shape as a function of the primary information may take place, for example, by part of the primary information, or the complete primary information, being reproduced in openly legible or encoded form by the shape of the respective label. The relationship may also be such that a specific shape is assigned to each primary information item and, when the primary information is read, all that occurs is an identity check with a corresponding database.

An alternative form of the production of the labels is one wherein, first of all, the individual shape of the respective label is formed, and subsequently the primary information is introduced. Using a clocked shift register within a clocked machine, it is then possible to ensure the correct assignment of primary information and label shape. It is also possible first to read the individual shape by means of a camera, or the additional information, and then to introduce the primary information.

In a preferred embodiment, the individual shape of the label is formed in such a way that it or additional information coded by the shape is also, or exclusively, machine-readable, by means for example of a photo sensor, an optionally modified barcode reader or a camera. In this way the security feature of the individual label shape can also function as a level 2 and/or level 3 security feature. Furthermore, after the additional information has been introduced, there can be an automatic check made that the forming of the additional information has been successful. In this way it is possible to remove off-specification production material immediately.

In a further-preferred embodiment, moreover, the designing of the labels with individual shape may be combined with a tamper evident effect, in other words an effect that indicates a detector of first-time opening. The detector of first-time opening may be the same for all labels, but more particularly the detector of first-time opening may also be formed individually for each label, and preferably correlated with the additional information provided by the individual shape of the label. By means of a correlation it is possible for the individual security features to be protected more effectively against counterfeiting or manipulation, since counterfeiting or manipulation remains undiscovered only when all of these features are counterfeited simultaneously. As is fundamentally known, the detector of first-time opening may be accomplished by means of a suitable layer construction. On this point reference is made, by way of example, to DE 100 30 596 A1.

As has already been described above, in a preferred embodiment of the method, the additional information provided by the individual shape is coded. Coding may take place, for example, by the introduction of a barcode-like identification. A further, preferred variant forms a coding by means of a specific variation in the length, the width and/or the length and width ratios of label to label and also, where appropriate, within different regions of a label. Different lengths and widths are relatively simple to vary. Nevertheless, a multiplicity of different information can be reproduced by means of appropriate coding.

With further preference, the individual labels have a conductive layer and/or a magnetic layer. Where the additional information in the case of such an embodiment is coded by a variation in the total area or by a variation in the lengths and widths of the label, the additional information, as a result of the conductive and/or magnetic layer, can then be read capacitively or magnetically.

In a further-preferred embodiment, the label, when the external shape is formed, is provided additionally with a feature which can be perceived by tactile means. Forming may take place, for example, by a suitable thickness of the label material and/or by the formation of a bead when the label web is cut; in particular, therefore, a tactile feature is performed by a change in the thickness of material within a label. A feature which can be perceived by tactile means preferably does not extend over the entire label but instead only in partial regions.

Further details, features, objectives and advantages of the present invention are elucidated in more detail below with reference to a drawing of one preferred exemplary embodiment. In the drawing

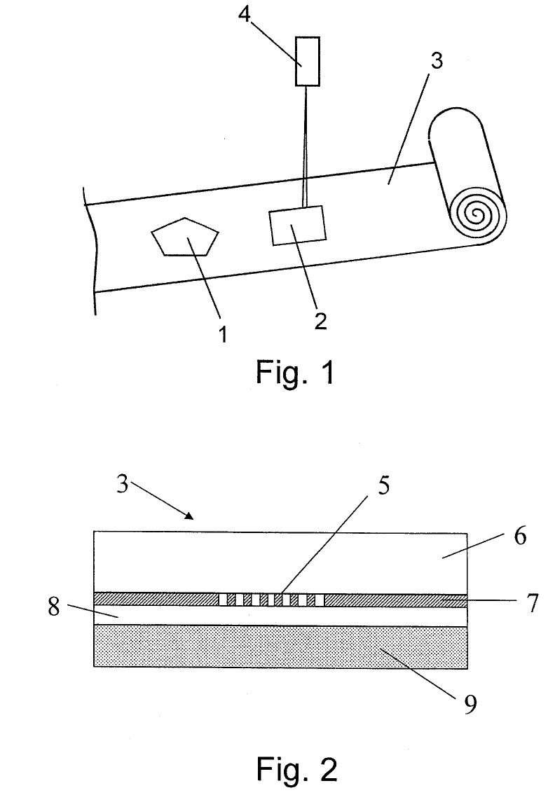

FIG. 1 shows the machining of a label web in diagrammatic representation,

FIG. 2 shows the label web of FIG. 1 in cross-section,

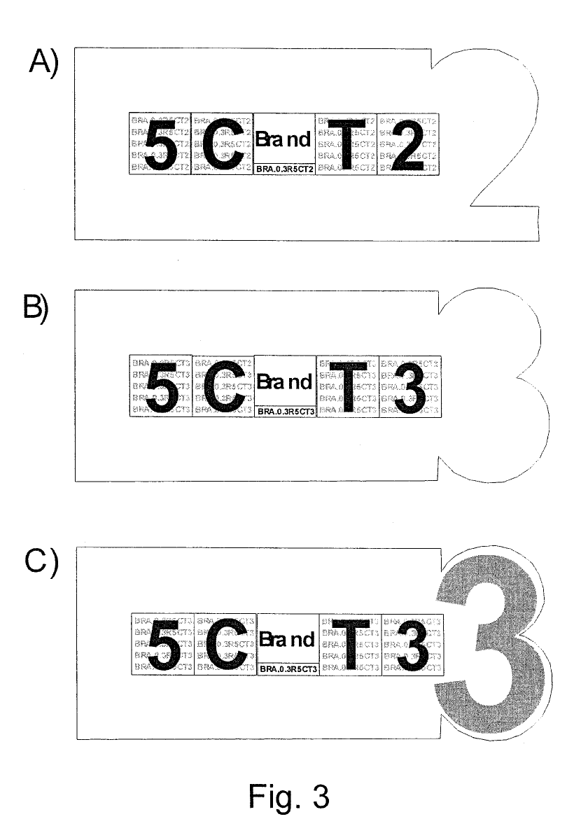

FIG. 3 shows a plurality of labels with different shapes, and

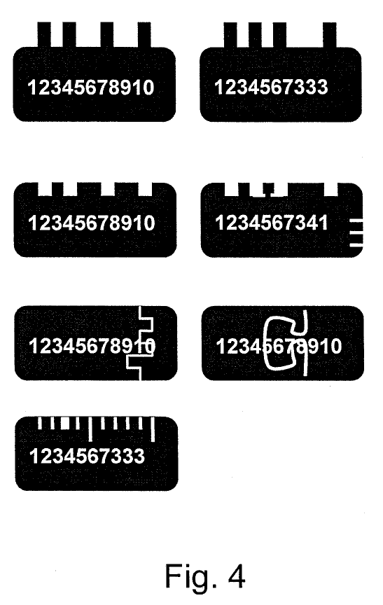

FIG. 4 shows alternative embodiments of labels.

FIG. 1 shows, in diagrammatic representation, the production and individualization of labels 1, 2 from a label tape 3. In the present case the label tape 3 is a multi-layer film arrangement wound into a role, of the kind typically used for the production of labels. Also suitable alternatively are label sheets from which a plurality of labels may be obtained. With regard to the layer construction of the label tape 3 in more detail, reference is made to the description relating to FIG. 2.

In the embodiment shown, in order to individualize the labels 1, 2, the label tape 3 is unwound and guided along beneath a laser lithograph 4. The laser lithograph 4 introduces primary information 5 in the form of an individual inscription into the label tape 3 and, furthermore, cuts the label tape 3 into individual labels 1, 2. Each of these labels 1, 2 has an individual external shape and is therefore individualized. Alternatively, the label tape 3 or the labels 1, 2 may also be inscribed beforehand or afterwards. Advantageous, however, is an embodiment in which the introduction of the primary information and the forming of the labels 1, 2 take place with the same instrument, more particularly with the same laser lithograph.

The shape of the labels 1, 2 is designed here and preferably not just individually, but instead also reproduces further information. This additional information is correlated with the primary information 5 of the labels 1, 2, so that by this means the security against counterfeiting is additionally enhanced. This applies more particularly when, as in the present case, the primary information 5 already offers a high standard of security. The high security standard of the primary information 5 is obtained in the present case by the primary information 5 being formed in any case partially as an individualized, computer-generated hologram.

FIG. 2 shows the label web 3 in the form of a multi-layer film arrangement in cross-section. The label web 3 has a label backing 6 in the form of a polyester film with a thickness of approximately 100 μm. Disposed beneath the label backing 6 is a thin marking layer 7, which in the present case is used as a medium of the primary information 5; in other words, a computer-generated hologram is written into this layer by laser lithography. In the present case the marking layer 7 and the label backing 6 together form an information layer arrangement. Also conceivable, however, are other embodiments, particularly with further intermediate layers.

The marking layer 7 is a metal layer, specifically an aluminium layer, having a thickness of several nanometres, in the present case approximately 5 nm. Disposed beneath the marking layer 7 there is an adhesive layer 8, here and preferably based on a pressure-sensitive adhesive, by means of which the subsequent labels 1, 2 can be fixed to any desired substrates. For the protection of the adhesive layer 8 and for the simplification of the handling of the subsequent labels 1, 2, the adhesive layer 8 is provided with a temporary release liner 9. In general the release liner 9 remains on the adhesive layer 8 until the labels 1, 2 are attached at the desired location. When the labels 1, 2 are shaped, the release liner 9 may for this purpose likewise be shaped accordingly and severed. In this case it is possible, where appropriate, for a further in-process carrier to be provided beneath the release liner 9 during the individualization method.

FIG. 3A, B shows individualized labels 1, 2, which in addition to the individual shape have primary information 5 in the form of an alphanumeric character sequence in combination with a computer-generated hologram. The embodiments depicted are exemplary embodiments which utilize the fact that, in the case of serial numbering, in the normal case, at least the last digit varies from one mark to the next and hence also a contour of the label 1, 2 that is correlated therewith. Regarding the form of the labels, it can be seen that the contour of the right-hand edge of the respective label 1, 2 reproduces the contour of the last digit of the alphanumeric character sequence, in the present case the numbers 2 and 3, respectively. In order to obtain a greater diversity of labels, it is of course also possible for the outer contour to reproduce the entire alphanumeric character sequence. In the case of the label shown in FIG. 3C, the perception of the outer contour is reinforced by virtue of the right-hand margin of the label being additionally inscribed with the same information, in this case the number 3.

FIG. 4 shows further examples of individualized labels. In this case there is not only a correlation with written primary information 5, in the present case a serial number. Instead, furthermore, there is also a coding of the additional information stored in the shape of the label. A simple form of coding is represented, for example, by lateral incisions or notches in the label or else cutouts within a label. Their number may correspond, for example, to the last digit of the serial number. A more complex coding may, for example, utilize the notches in order to achieve, for example, a binary representation of the serial number. Five notches might, for example, code the last digit of a serial number: e.g. no notches for 0, ----v for 1, ---v- for 2, ---vv for 3, etc, where “v” represents a notch at the respective location. It is likewise conceivable to utilize readily recognizable shapes which correlate with the last digit of the serial number: 0, for example, corresponds to a round label, 1 corresponds to a rectangular label; 2 corresponds to an elliptical label, 3 corresponds to a triangular label, etc.

1. Method of individualizing labels (1, 2), comprising the steps of
forming, in a label tape (3), a plurality of labels (1, 2) having a shape,
individualizing the shape of each label (1, 2).

2. Method according to claim 1, wherein primary information (5) in the form of printing and/or stored information, is introduced into the 1 label (1, 2).

3. Method according to claim 1, wherein the individual shape of a label (1, 2) is formed as additional information, preferably in that the additional information is formed machine-readably.

4. Method according to claim 2, wherein the primary information (5) of the label (1, 2) is read and subsequently the additional information is formed.

5. Method according to claim 2, wherein the primary information (5) and the additional information are correlated.

6. Method according to claim 3, wherein the additional information is coded, by coding the additional information by length and/or width of the label (1, 2) and/or by different length and/or width ratios of the label (1, 2).

7. Method according to claim 6, wherein the additional information is coded by a machine-readable structure, in that at the margin or margins of the label (1, 2), and/or in that the additional information is coded by the total area of the label (1, 2).

8. Method according to claim 6, further including the step of
providing the label (1, 2) with a conductive layer and/or a magnetic layer and forming additional information such that it can be read capacitively and/or magnetically.

9. Method according to claim 1, wherein the shape of the label (1, 2) is formed by laser lithography, preferably in that both the primary information (5) and the additional information are introduced by laser lithography into the label (1, 2).

10. Method according to claim 1, wherein the individual shape of the label (1, 2) is formed as a level 2 security feature and/or as a level 3 security feature.

11. Method according to claim 1, wherein the label (1, 2) is formed with a detector of first-time opening, preferably in that the detector of first-time opening is correlated with the additional information.

12. Label, produced according to claims 1, comprising
an information layer arrangement,
primary information (5) capable of being written into the information layer arrangement, wherein the label (1, 2) has an individual shape, and the individual shape is a carrier of additional information.

13. Label according to claim 12, wherein the additional information can be read in part or completely without auxiliary means.

14. Label according to claim 12, wherein the additional information is partly or fully coded.

15. Label according to claim 12, wherein the primary information (5) is correlated with the additional information, preferably in that the correlation between primary information (5) and additional information is obtained by the additional information at least partly reproducing the contour of the primary information (5).

16. Label according to claim 12, wherein the additional information is formed at least partly by cutouts in the label (1, 2).

17. Label according to claim 12, wherein the primary information (5) is introduced at least partly superficially into or onto the information layer arrangement and/or in that the primary information (5) is introduced at least partly into the volume of the information layer arrangement.

18. Label according to claim 12, wherein the primary information (5) includes a diffractive element.

19. Label according to any one of claims 12, wherein the primary information (5) is formed as laser writing.

20. Label according to any one of claim 12, wherein the label has an adhesive layer (8) and is formed as a self-adhesive label (1, 2).

21. Label according to claim 18, wherein the diffractive element is a computer-generated hologram.

22. Label according to any one of claim 12, wherein the primary information (5) is formed as laser writing, and wherein both primary information (5) and additional information has been written by laser lithography into the label (1, 2).

23. Label according to claim 12, wherein the primary information (5) is formed as laser writing, preferably in that both primary information (5) and additional information has been written by laser lithography into the label (1, 2).

24. Label according to any one of claim 12, wherein the label has an adhesive layer (8) and is formed as a heat-sealable label (1, 2).
